(19) United States
(12) Patent Application Publication
(10) Pub. No.: US 2003/0026392 A1
(43) Pub. Date: Feb. 6, 2003

(54) Method and apparatus for extracting information from voice messages

(76) Inventors: Charles M. Brown, Redwood City, CA (US); David W. Curbow, Sunnyvale, CA (US)

Correspondence Address: BRIAN M BERLINER, O'MELVENY & MYERS, 400 SOUTH HOPE STREET, LOS ANGELES, CA, 90071, US

(21) Appl. No.: 09/924,224

(22) Filed: Aug. 6, 2001

(51) Int. Cl. H04M 11/00

(52) U.S. Cl. 379/88.13

(57) ABSTRACT

Current voice message systems typically operate by recording a message that people leave for a user. However, these current systems do not process the message in a manner where significant information, such as phone numbers, meeting times, and locations, is identified, extracted, and output. The present invention solves the current system's limitations and extracts pertinent data from a voice message. In addition, the present invention is versatile because it is applicable to a recorded or live voice message, and any type of phone can actuate the extraction mechanism. The invention builds on voice recognition technology by identifying data, for instance, common phrases and strings of numbers from a voice message. Next, the invention provides an interface for actuating extraction technology. In one embodiment, the extraction technology removes information based on user commands according to a series of keystrokes. In another embodiment, the invention extracts information by a user's voice commands. Consequently, when a telephone user encounters a situation where he/she is unable to write down a phone number or other information, the user will be able to quickly access the invention to find the number or other piece of relevant information and save it for retrieval later. This invention saves the user time and frustration from constantly replaying the same message. It also saves money by reducing fees from repetitive and redundant telephone calls. With simple keystrokes or voice commands, a user can immediately access extracted information and make his/her desired telephone call.

### BACKGROUND

1. Field of the Invention

This invention relates to the field of voice recognition and specifically to a method and apparatus for extracting information from a voice message.

Portions of the disclosure of this patent document contain material that is subject to trademark protection. The trademark owner has no objection to the facsimile reproduction by anyone of the patent document or the patent disclosure as it appears in the Patent and Trademark Office file or records, but otherwise reserves all rights whatsoever. Sun, Sun Microsystems, and MAJC, are trademarks or registered trademarks of Sun Microsystems, Inc. in the United States and other countries.

2. Background Art

Sometimes a person listening to a telephone message needs to write down a phone number so he/she can immediately return a call or save the number for later. This is a problem when the user is in a place where he/she is unable to write down important information. For example, a user may find it difficult to write down pertinent information when driving in a car, riding public transportation, walking, or are in the middle of some other activity. Furthermore, it is often dangerous to become distracted by writing down information while performing these activities.

Often a telephone user needs to call someone immediately, but is unable to do so because of engagement in another activity, or bad memory. Furthermore, callers often leave a long telephone message with a telephone number hastily added at the end. In order to retrieve the telephone number from the message, a telephone user usually has to replay the long message repeatedly. The continuous replay of the same message wastes time, frustrates the telephone user, and may increase the telephone bill.

Current voice mail systems do not process the content of a telephone message in a manner that relieves the user from writing down pertinent information or replaying the message over and over again. Some systems that attempt to assist a telephone user from the hassle of replaying a message are referred to herein as caller identification (“Caller ID”), star sixty-nine (“Star 69”), and pager. However, the primary focus of these systems is not to reduce a user's replay of messages. Therefore, these systems have some disadvantages as described below.

Caller ID

Caller ID allows a user to determine the phone number of an incoming phone call. Another function of Caller ID identifies and stores an incoming telephone number into a log. This log can hold many telephone numbers, and usually contains the caller's telephone number, date, and time called. In order to access a number to return a call, a telephone user can typically press a few buttons to scroll through a display list of the log to select a desired telephone number. However, Caller ID is not always effective in retrieving a desired telephone number, and there are numerous reasons why caller ID is unable to identify phone numbers. First, it is often the case that a telephone number is a private number that blocks caller ID systems from identifying it. Second, problems are created when a person calls from an office environment. Some office telephone services transfer an outbound telephone call to the first available outside phone line that is automatically selected from a list of available telephone numbers. If a user dials the telephone number displayed in the caller ID log, a user may be unable to contact the person that called because the phone number is wrong. Third, a caller may have more than one telephone number where he/she can be reached. For example, home, office, pager, cellular, etc., but the caller ID feature captures only one of the many choices available for the called party to return the call. Finally, a caller may leave an alternate telephone number in the message instead of the number he/she is calling from. A caller may do this because he/she may be leaving the location from where the call is placed, and may only be reached at another location. Caller ID does not account for these changes. Thus, a user is unable to reach the intended party and wastes time dialing the wrong telephone number.

Star 69

Star 69 is a service provided by phone companies that dials the last phone number received by a user's telephone. In order to dial the last phone number, a user must perform a series of simple steps. A telephone user first presses the star key “*”, which is typically the bottom left digit key on a standard phone pad located next to the zero “0” key. Next, the user presses the number six “6” key followed by the number nine “9” key to activate the Star 69 service. Unfortunately, this service is consistently unsuccessful at retrieving the most recent phone number that called a user's telephone.

Star 69 encounters similar problems as caller ID. For example, a private number disables the service, a random number automatically selected from an office telephone service does not provide a direct phone number to call back, and a caller often leaves alternate numbers where he/she can be reached. In addition, a call made from out of the country (overseas long distance call) is not recognized by the Star 69 service. Furthermore, the last number a user receives is not necessarily the telephone number of the person a user wants to call. The Star 69 service does not output the telephone number either as text, or voice, instead it automatically dials and connects the user to the last number received. Therefore, a telephone user does not know whom he/she is calling, and further a user may not want to talk to that person at that particular moment.

Pager

A pager is a device that allows a person to contact the person who holds the pager at some remote location. In general, when a person calls a pager number, a prompt asks the person to enter a telephone number by pressing the corresponding number keys on the keypad. The telephone number entered is usually the one from where the call is made. Some pagers also have the capability of receiving a brief message, or a combination of the telephone number and message. Once a person enters the necessary input, a signal is transmitted to the pager that notifies its holder of the new message. A traditional pager can only receive transmissions which are either output as text on a display screen, or stored as voice messages.

Pagers range in levels of sophistication. Typically a lower end model only displays telephone numbers. However, current pagers have the capability of displaying telephone numbers and brief text messages. Additionally, some current models have caller ID capabilities too. It is relatively easy for a pager holder to receive text messages because they can be displayed on the screen. However, in order to retrieve a voice message, a pager user must call the pager voice mail service. Thus, if a user has a cellular phone, owning a pager seems unnecessary because cellular phones perform similar functions.

Thus, a pager is limited in its options, and experiences similar problems as Caller ID and Star 69. In addition, a pager holder sometimes receives a wrong telephone number because it did not transfer completely, or the caller inputted the number incorrectly. Another problem occurs when there is no corresponding text message because the pager holder does not know whom to call back. These problems leave a user with an inability to extract pertinent information from a message and return phone calls promptly.

Consequently, these previously mentioned voice mail systems do not assist a telephone user from continuously replaying the message when a telephone number is needed but are unable to write down the information. Furthermore, many of these services are offered by telephone companies, and hence cost additional fees. What is needed is a mechanism for extracting relevant information from a telephone message without replaying it repeatedly.

### SUMMARY OF THE INVENTION

The present invention is a method and apparatus for extracting information from a voice message. In one embodiment, the invention is integrated into the voice mail service and cellular phone display. In another embodiment, the invention adds an additional button to a conventional telephone keypad that is used to activate the extraction application. Therefore, when a telephone user encounters a situation where they are unable to write down the information, they can easily extract and dial necessary telephone numbers, or other pertinent information by activating the present invention.

The invention is built on voice recognition technology by identifying common phrases and strings of numbers from a voice message. Next, the invention provides an interface for actuating extraction technology. In one embodiment, the extraction technology collects information based on user commands. User commands can be verbal or can be inputted by a series of keystrokes.

Consequently, when a telephone user encounters a situation where they are unable to write down information, users can quickly access the present invention to find a phone number or other piece of relevant information. This invention saves the user time, and the frustration of constantly replaying the same message. It also saves a user money by reducing telephone fees spent on repetitive and redundant telephone calls. With simple keystrokes or voice commands, a user can immediately access extracted information and make the desired telephone calls.

### BRIEF DESCRIPTION OF THE DRAWINGS

FIG. 1 is a flowchart showing how to extract information from a voice message according to one embodiment of the present invention.

FIG. 2 is a flowchart showing the operational embodiment of the present invention from a user's perspective.

FIG. 3 is a flowchart showing how the data extraction mechanism processes information according to one embodiment of the present invention.

FIG. 4 is a flowchart showing how to locate phrases with which to extract information from a voice message according to one embodiment of the present invention.

FIG. 5 is an illustration of one embodiment of a touch-tone phone that contains a typical twelve-button configuration.

FIG. 6 is an illustration of one embodiment of a cellular phone (Nokia™ Model 6160) with an additional button to actuate the mechanism for extracting telephone numbers and other information from a voice message.

FIG. 7 is a flowchart showing how to output extracted information from a voice message according to one embodiment of the present invention.

FIG. 8 is a flowchart showing how to output data according to one embodiment of the present invention.

### DETAILED DESCRIPTION

A method and apparatus for extracting information from a voice message is described herein. In the following description, numerous specific details are set forth in order to provide a more detailed description of the invention. It will be apparent, however, to one skilled in the art, that the present invention may be practiced without these specific details. In other instances, well known details of the way phone calls are routed by telephone companies, or the telecommunication technology used by telephone companies have not been provided so as to not unnecessarily obscure the invention.

Current voice message systems typically operate by recording and storing a message that a caller leaves for the user. However, these current systems do not process a message in a manner where pertinent information, such as phone numbers, or meeting times and locations, is identified, extracted, and outputted. The present invention solves these current systems' limitations and extracts certain key data from a voice message. In addition, the present invention is versatile because it is applicable to text messages, and recorded or live voice messages, and furthermore, any type of telephone can actuate the extraction mechanism.

In one embodiment, the present invention builds on voice recognition tools by applying its technology towards extracting pertinent information from a voice message. First, the invention uses voice recognition technology to turn a voice (speech) message into a computer usable form of data (text). Second, the invention employs pattern-matching tools to identify and extract key information selected by the user. Third, the selected information is converted from speech to text, and finally, it is outputted to the user. The order of steps two and three above can be interchanged and still produce similar results.

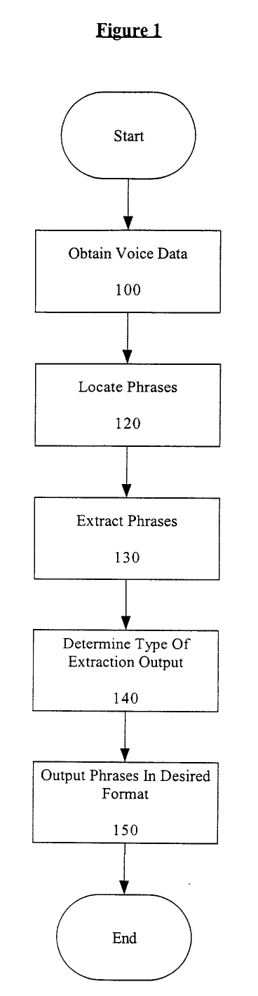

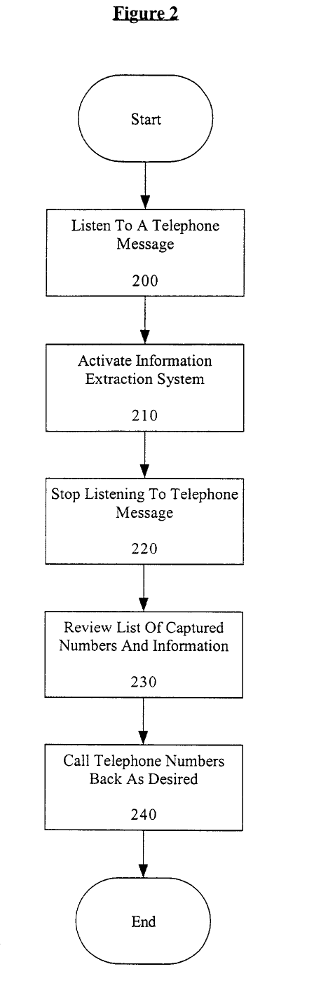

FIG. 1 is a flowchart showing how to extract information from a voice message according to one embodiment of the present invention. At step 100, voice data is obtained. The voice data comes from voice messages received by a voice recording mechanism. At step 120, phrases are located. The present invention employs voice recognition technology that identifies certain phrases that are usually linked with important information, such as “my home number is”, “meet me at”, “call me at”, “my e-mail address is”, “my fax number is”, or “my cellular number is”. Alternately, the present invention can also identify spoken numbers, as in “call one eight hundred one two three four five six seven”. The present invention contains a vast database of these important phrases, and a user can update the database to encompass special jargon or industry dialogue. Next, at step 130, the phrases are extracted. At step 140, the type of extraction output is determined. In one embodiment of the present invention, voice messages are output in numerous ways, to include a preprocessing output, live processing output, and post-processing output. Finally, at step 140, the phrase is output.

In one embodiment, the pre-processing output allows a user to receive extracted information from a voice message before the user listens to the message. Sometimes a user may receive numerous telephone messages on the answering machine, and may not have time to listen to each message completely. The pre-processing output saves valuable time because the user can receive pertinent voice message information, such as telephone numbers and appointment information, without listening to each entire message. The user is able to quickly review the pertinent information from each message identified by the voice extraction mechanism. Additionally, this method continues to store entire voice messages for the user to retrieve at a more convenient time. FIG. 9 shows an illustration of a voice mail summary example. This display can be viewed, for example, on a PDA (Personal Digital Assistant) or computer (desktop or laptop) screen, or a LCD (liquid crystal display) panel on a car dashboard. The illustration shows a table of callers along with other pertinent information like name of callers, date and time of calls, best times to call back along with one or more return numbers. Other columns can be added by the user, and may include e-mail addresses, meeting times, web site URLs (Uniform Resource Locators), etc. If the display is on a LCD panel on a car dashboard, the user can touch the screen to automatically dial the telephone number of a person on the list, or perform other functions like storing the information of a caller in a directory, or making changes to the number and type of columns displayed on the screen. For a desktop computer, the user can perform the same tasks using a mouse pointer, while in the case of a PDA the same tasks may be performed using a stylus pen.

The live processing output, according to one embodiment, allows a user to receive extracted information from a voice conversation as the user is engaged in the conversation. Sometimes a user receives a telephone call and is unable to write down important information. In addition, the user may be occupied by some other activity where he/she is unable to hear every detail of the conversation. For example, during a conference call, a user often takes notes, searches for information in a book or via the internet, or prepares related documents. Thus, when the live processing output is activated, a user does not have to worry about manually writing down the pertinent information.

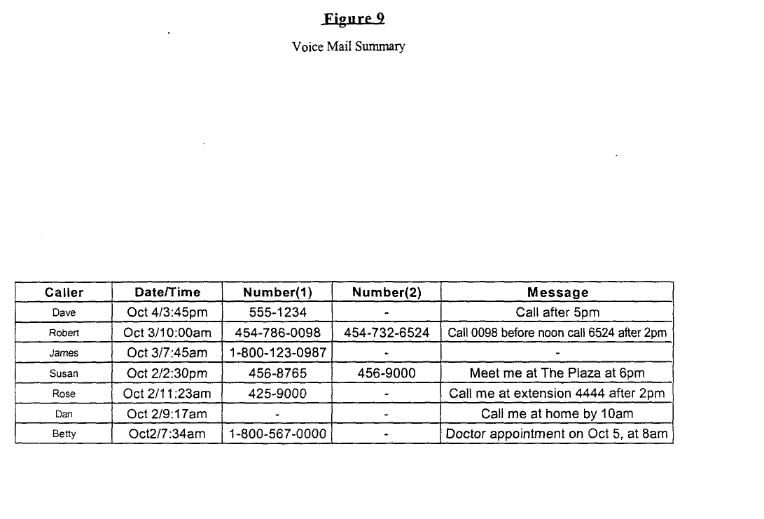

According to another embodiment, the post processing output allows a user to receive extracted information from a voice message after the user listens to the message. Sometimes a user receives numerous telephone messages on the answering machine, and may not have time to listen to every message completely, or is unable to write down all of the pertinent information as the messages are being played. However, the post-processing output alleviates a user from this burden. After a user has listened to the entire message, the pertinent information which is extracted by the voice extraction mechanism can be quickly reviewed. The voice mail summary illustrated in FIG. 8 can work for all pre, post, and live processing features of the present invention.

Activation

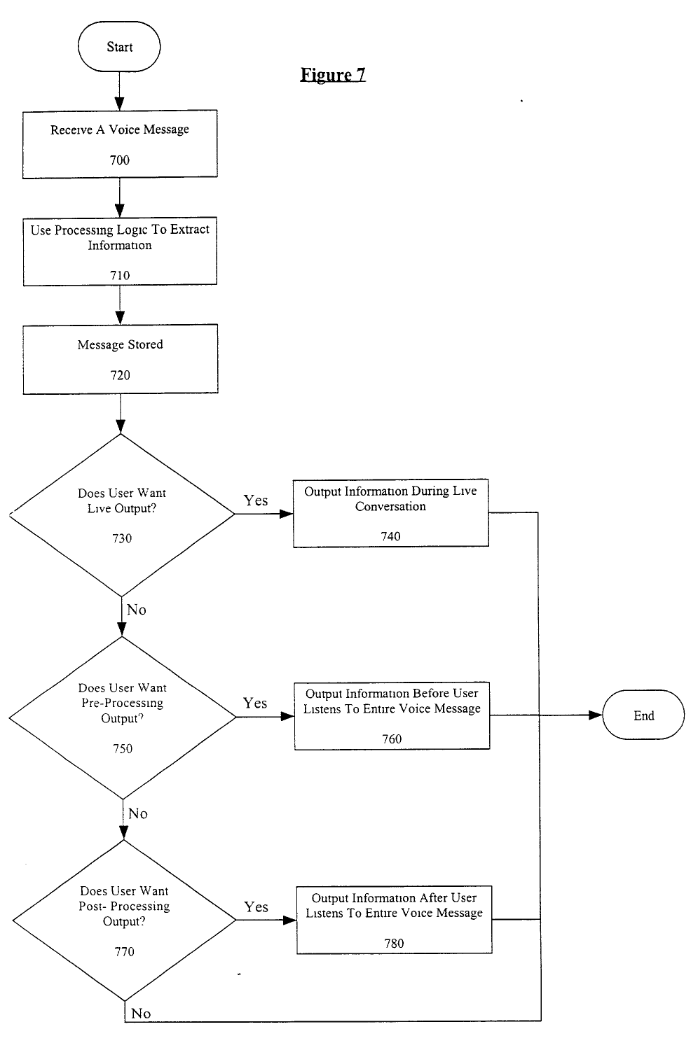

A user has numerous options to activate the present invention. In one or more embodiments, the invention: uses existing buttons on a telephone keypad, uses additional buttons added to a telephone, or is driven by voice commands. In another embodiment, the system is actuated with a twelve-button telephone configuration or through voice commands. Since the invention uses existing phone hardware, the user does not have to invest in a new kind of telephone. This is a savings to not only the user, but to the telephone manufacturing company. FIG. 6 is an illustration of one embodiment of a cellular phone (Nokia™ Model 6160) that contains a typical twelve-button configuration.

As previously stated, one of the ancillary goals of this invention is to reduce the cost for a telephone user. This invention achieves this goal because a user can activate the data extraction service without purchasing a new telephone with additional buttons. However, as telephones, and specifically cellular phones, contain more options and perform more functions, the current telephone configuration may be unable to handle all of the additional options. Thus, a natural progression in their development may be to add new buttons to the existing telephone interface. Consequently, the present invention contemplates the use of any telephone design, and is versatile because of its numerous activation capabilities.

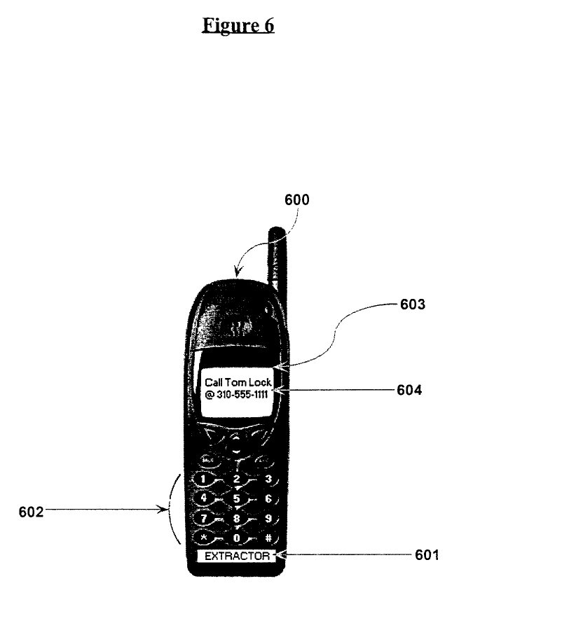

FIG. 5 is an illustration of one embodiment of a telephone that contains a typical twelve-button configuration. The telephone (500) shown in FIG. 5 is a standard telephone, however, one skilled in the art will know that users can activate the present invention with any type of telephone and any number of keypad combinations. In one embodiment of the invention, a user presses various keypad combinations to activate the data extraction device. For example, a user first activates the data extraction device by pressing pound sign button 501 during a live message, or replay of a recorded message. Pound sign button 501 is located in the bottom right corner of a typical twelve-button configuration 502. Next, the pertinent information 504 is displayed. Pertinent information may include, for example, a telephone number and name of person to contact, on telephone screen 503. However, one skilled in the art will know that the present invention can output the information in text, voice, or other formats. If a user desires to contact the person on display 503 immediately, he/she presses pound sign button 501 again to dial the telephone number.

FIG. 6 is an illustration of one embodiment of a cellular phone that has an additional button to actuate the mechanism for extracting telephone numbers and other information from a voice message. The telephone shown in FIG. 6 is a cellular phone 600 (Nokia™ Model 6160). However, one skilled in the art will know that a manufacturer can place additional buttons or other activation mechanisms on any type of telephone. In one embodiment, a user presses extraction button 601 during a live message, or replay of a recorded message to activate the data extraction device. In one embodiment, extraction button 601 is located under a typical twelve-button configuration 602. Next, pertinent information 604 is displayed on activating extraction button 601. Pertinent information may include, for example, a telephone number and name of person to contact, on cellular phone screen 603. However, one skilled in the art will know that the present invention can output the information in text, voice, or other formats. If a user desires to contact the person on display 603 immediately, he/she presses extraction button 601 again to dial the telephone number.

Identification and Extraction of Data

The present invention is versatile because it possesses numerous identification and data extraction capabilities. In one embodiment, the invention converts a voice message into a text message before activating the data extraction device. However, in another embodiment of the invention, it extracts data and other pertinent information directly from a voice message. In either embodiment, the present invention identifies key phrases within a telephone message by using recognition and pattern matching technology to extract the desired information. The present invention enables a user to return telephone calls immediately without writing information down. In addition, a user can quickly scan all of the messages for relevant information rather than listen to each entire message.

The present invention builds on data recognition technology and applies it to a voice message that has been converted to text. This benefits a user especially when he/she has many messages to listen to or the messages are lengthy. Instead of listening to all of the messages or just skipping them altogether, a user can scan a brief summary output of all of the messages. Allowing a user to view summaries of messages rather than listening to entire messages or saving them for later is very advantageous especially when time is a concern.

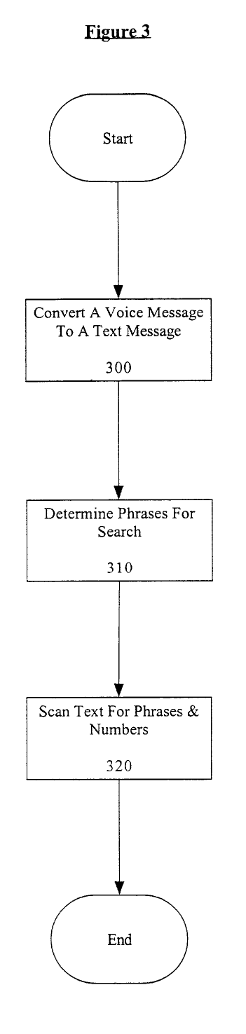

FIG. 2 is a flowchart of the operation of one embodiment of the present invention from a user's perspective. At step 200, a user listens to a live or recorded telephone message. Next, at step 210, the user activates the information extraction system. Then, at step 220, the user stops listening to the telephone message. Next, at step 230, the user reviews a list of captured telephone numbers and information. Finally, at step 240, the user calls the desired telephone numbers.

Data Extraction

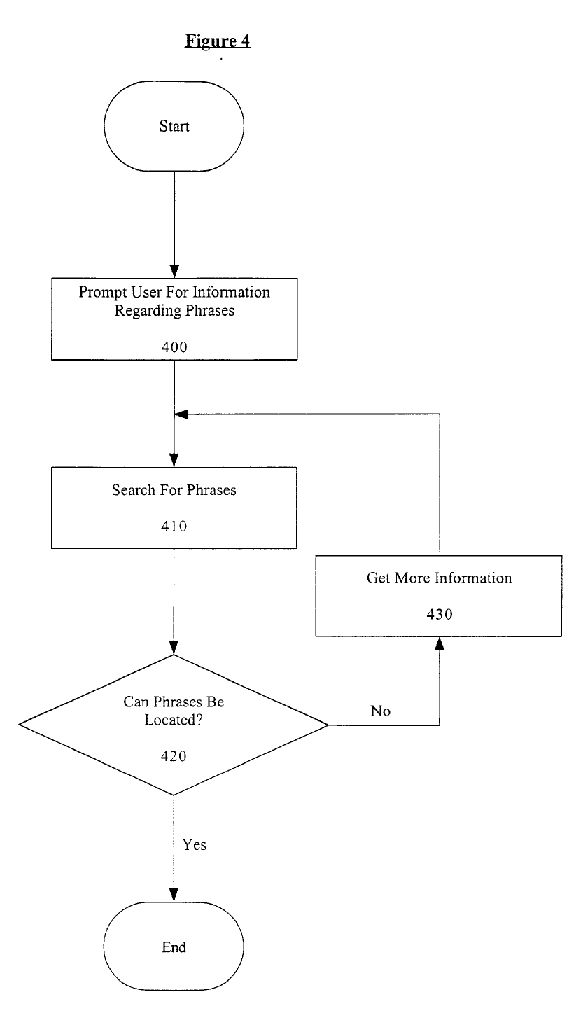

FIG. 3 is a flowchart showing how the data extraction mechanism processes information according to one embodiment of the present invention. At step 300, a voice message is converted into a text message. Next, at step 310, a phrase is determined for the pattern search. Numerous strings of phrases exist in the database in order to identify pertinent information for extraction. For example, in one embodiment configured to extract telephone numbers and extensions, some phrases contained in the invention's database are, for example, “call me at”, “number is”, “reached at”, “give me a ring at”, and “extension”. Additionally, in another embodiment that extracts meeting times and event locations, some phrases contained in the invention's database are, for example, “meeting is at” “get together at”, “here at”, “location”, “morning at”, “afternoon at”, “evening at”, “o'clock”, “work”, “home”, and “office”. Alternately, in another embodiment that extracts spoken numbers, some phrases contained in the invention's database are, for example, “one eight hundred one two three four five six seven”, and “two three seven six one four six extension four”. Finally, at step 320, telephone numbers and phrases are scanned and located.

Phrase Location

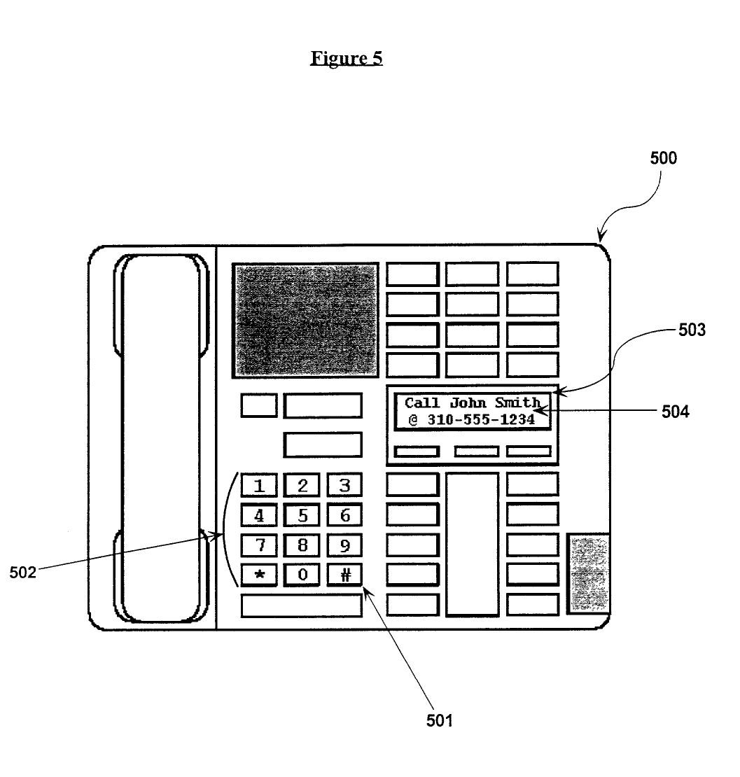

FIG. 4 is a flowchart showing how to locate phrases with which to extract information from a voice message according to one embodiment of the present invention. At step 400, a user is prompted for information regarding a specific phrase. For example, if a user only wants to obtain information regarding meeting times, the user only activates the data extraction mechanism for meeting times. The invention subsequently scans all of the messages and only outputs information that relates to meeting times. Next, phrases identified at step 400 are searched for in all of the messages at step 410. Then, at step 420, it is determined whether the identified phrases can be located. If the identified phrases cannot be located, more information is obtained at step 430, and the process repeats itself at 410. Otherwise, if the identified phrases are located at step 420, the phrases are extracted.

Phrase Output

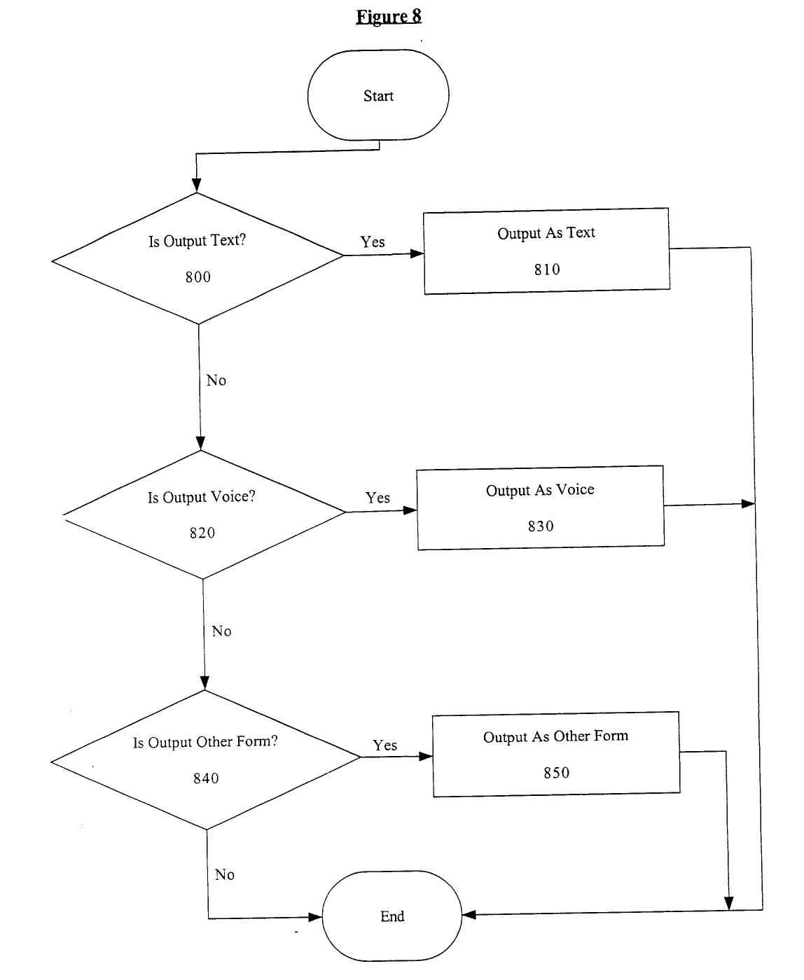

FIG. 7 is a flowchart showing how to output extracted information from a voice message according to one embodiment of the present invention. At step 700, a voice message is received by a voice recording mechanism. Next, at step 710, the voice data is filtered through the processing logic mechanism that extracts the pertinent information. At step 720, the extracted information is stored.

At step 730, it is determined if the user wants a live output of the extracted information. If the user wants live output of the extracted information, the extracted information is output during a live conversation at step 740. If the user does not want live output of the extracted information, it is determined if a user wants a pre-processed output of the extracted information at step 750. Next, if the user wants pre-processed output of the extracted information, the extracted information is output before the user listens to the entire recorded voice message at step 760. If the user does not want the pre-processed output of the extracted information, at step 770, it is determined if a user wants a post-processed output of the extracted information. Next, if the user wants post-processed output of the extracted information, the extracted information is output after the user listens to the entire recorded voice message at step 780. Finally, if the user does not want the post-processed output of the extracted information, the process ends without outputting the extracted information.

FIG. 8 is a flowchart showing how to output data according to one embodiment of the present invention. At step 800, the data is analyzed to determine if the data requires a text output. If so, at step 810, the data is output as text. Next, at step 820, the data is analyzed to determine if the data requires a voice output. If so, at step 830, the data is output as voice. Finally, at step 840, the data is analyzed to determine if the data requires some other form of output. If so, at step 850, the data is output in some other form.

Thus, a method and apparatus for extracting information from a voice message is described in conjunction with one or more specific embodiments. The invention is defined by the claims and their full scope of equivalents.

1. A method of extracting information from voice messages comprising:
obtaining a data item in a first format;
converting said data item to a second format;
searching said data item for said information;
extracting said information from said data item; and
outputting said information.

2. The method of claim 1 wherein said first format is voice data.

3. The method of claim 2 wherein said voice data comprises live and recorded voice messages.

4. The method of claim 3 wherein said second format comprises text.

5. The method of claim 4 wherein said information comprises one or more phrases.

6. The method of claim 5 wherein said phrases comprise, but is not limited to, “call me at”, “number is”, “extension is”, “one eight hundred one two three four five six seven”, “eight one four six five four two extension four”, and “give me a ring at”.

7. The method of claim 6 wherein said step of outputting comprises:
outputting said information in a plurality of formats.

8. The method of claim 7 wherein said one of said plurality of formats is text.

9. The method of claim 8 wherein said one of said plurality of formats is voice.

10. A computer program product comprising:
a computer usable medium having computer readable program code embodied therein configured to extracting information from voice messages, said computer program product comprising:
computer readable code configured to cause a computer to obtain a data item in a first format;
computer readable code configured to cause a computer to convert said data item to a second format;
computer readable code configured to cause a computer to search said data item for said information;
computer readable code configured to cause a computer to extract said information from said data item; and
computer readable code configured to cause a computer to output said information.

11. A computer program product of claim 10 wherein said first format is voice data.

12. A computer program product of claim 11 wherein said voice data comprises live and recorded voice messages.

13. A computer program product of claim 12 wherein said second format comprises text.

14. A computer program product of claim 13 wherein said information comprises one or more phrases.

15. A computer program product of claim 14 wherein said phrases comprise “call me at”, “number is”, “extension is”, “one eight hundred one two three four five six seven”, “eight one four six five four two extension four”, and “give me a ring at”.

16. A computer program product of claim 15 wherein said step of outputting comprises:
outputting said information in a plurality of formats.

17. A computer program product of claim 16 wherein said one of said plurality of formats is text.

18. A computer program product of claim 17 wherein said one of said plurality of formats is voice.

19. A voice message data extraction device comprising:
a data item in a first format;
a first apparatus for converting said data item to a second format;
a second apparatus for searching said data item for said information a third apparatus for extracting said information from said data item; and
a fourth apparatus for outputting said information.

20. The voice message data extraction device of claim 19 wherein said first format is voice data.

21. The voice message data extraction device of claim 20 wherein said voice data comprises live and recorded voice messages.

22. The voice message data extraction device of claim 21 wherein said second format comprises text.

23. The voice message data extraction device of claim 22 wherein said information comprises one or more phrases.

24. The voice message data extraction device of claim 23 wherein said phrases comprise “call me at”, “number is”, “extension is”, “one eight hundred one two three four five six seven”, “eight one four six five four two extension four”, and “give me a ring at”.

25. The voice message data extraction device of claim 24 wherein said fourth apparatus for outputting comprises:
outputting said information in a plurality of formats.

26. The voice message data extraction device of claim 25 wherein said one of said plurality of formats is text.

27. The voice message data extraction device of claim 26 wherein said one of said plurality of formats is voice.
